(19) United States
(12) Patent Application Publication
(10) Pub. No.: US 2022/0385016 A1
(43) Pub. Date: Dec. 1, 2022

(54) ELECTRICAL OUTLET CUTTING JIG

(71) Applicant: 4Cabling Pty Ltd, Alexandria, New South Wales (AU)

(72) Inventors: Chaminda MADDUMA PATABANDIGE, Alexandria (AU); Bilal COMERTPAY, Alexandria (AU); Luke STEPHENS, Alexandria (AU)

(21) Appl. No.: 17/804,488

(22) Filed: May 27, 2022

(30) Foreign Application Priority Data
May 28, 2021 (AU) 2021380856

(51) Int. Cl. H01R 43/01; H01R 43/18

(52) U.S. Cl. CPC H01R 43/01; H01R 43/18

(57) ABSTRACT

Disclosed herein is an electrical outlet cutting jig that includes a ruler and a body having a lower perimeter, wherein the body includes a first channel defined along a first axis of the body. The body also includes a first level indicator and a second level indicator orthogonal to the first level indicator to enable a user to align the cutting jig correctly. The first channel is configured to receive the ruler such that a lower surface of the ruler is flush with the lower perimeter of the body and such that the ruler can slide within the first channel. The ruler enables the user to position the body of the cutting jig at a predetermined distance from a location, such as a door frame, floor, skirting board, or the like.

### RELATED APPLICATION

This application claims priority to Australian Provisional Patent Application No. 2021901602 titled “Electrical outlet cutting jig” and filed on 28 May 2021 in the name of 4Cabling Pty Ltd, the entire content of which is incorporated herein by reference.

### TECHNICAL FIELD

The present disclosure relates to a cutting jig. In particular, the present disclosure relates to cutting jig suitable for use in relation to electrical outlets and the like.

### BACKGROUND

Modern homes and workplaces utilise an increasing number of electrical appliances. Electrical appliances require access to mains power. Further, an increasing number of electrical appliances require access to networked computer cabling. Such appliances include, for example, computers, televisions, set top boxes and media streaming devices.

As a consequence, there is an increasing need for electrical outlets. There are many different types of electrical outlets, including, for example, but not limited to, general purpose outlets (GPOs) for mains power, local area network (LAN) cabling, light switches, Universal Serial Bus (USB) charging ports, fan controls, or a combination thereof. Whilst there are many different types of electrical outlets, the outlet plates are generally rectangular in shape and of a consistent size.

In order to install a new electrical outlet in a plasterboard wall, it is necessary to cut a hole in the plasterboard of the right size and in the right location. Typically, a tradesperson utilises a file or a saw, such as a reciprocating saw, to cut or puncture an initial hole and then work through the plasterboard to achieve a hole of roughly the desired size. Similarly, installing a new electrical outlet in a wall of different material requires the tradesperson to cut into the wall at the right place. Wiring is then passed through to hole and secured to an outlet plate, which is generally rectangular in size and larger than the electrical outlet itself. This provides an aesthetically pleasing finish, as the outlet plate covers the electrical outlet, the outline of which may be quite rough due to fractured plasterboard.

It is common for a tradesperson to utilise a C-clip mounting bracket or other suitable bracket on an electrical outlet cut into plasterboard. The C-clip mounting bracket typically includes one or two clips to couple the C-clip mounting bracket to the hole in the plasterboard and includes at least one pair of threaded holes for receiving threaded screws or bolts from the outlet plate.

Electrical outlets are typically installed in an ad-hoc manner, with little thought given to the precise positioning of the electrical outlets. This can result in electrical outlets being installed at different heights throughout a premises. Further, tradespersons often install electrical outlets by sight alone, which often results in electrical outlets that are skewed and are not correctly aligned. Further still, tradespersons may cut an electrical outlet that is too large, such that the electrical plate does not cover the opening, resulting in a need to repair plasterboard.

A need exists to provide a device to facilitate the correct sizing, location, and orientation of electrical outlets.

### SUMMARY

The present disclosure relates to an electrical outlet cutting jig.

A first aspect of the present disclosure provides an electrical outlet cutting jig including:

a ruler; and

a body having a lower perimeter,
wherein said body includes a first channel defined along a first axis of said body, the first channel being configured to receive the ruler such that a lower surface of the ruler is flush with the lower perimeter of the body and such that the ruler can slide within the first channel, and
wherein said body includes a first level indicator and a second level indicator orthogonal to said first level indicator.

In some embodiments, the lower perimeter has dimensions relating to an electrical outlet, wherein the electrical outlet is selected from the group consisting of: a general purpose outlet (GPO) for mains power, a local area network (LAN) cabling plate, a light switch, a Universal Serial Bus (USB) charging port plate, and a fan control plate.

According to another aspect, the present disclosure provides an apparatus for implementing any one of the aforementioned methods.

Other aspects of the present disclosure are also provided.

### BRIEF DESCRIPTION OF THE DRAWINGS

One or more embodiments of the present disclosure will now be described by way of specific example(s) with reference to the accompanying drawings, in which:

FIG. 1 illustrates an embodiment of an electrical outlet cutting jig in accordance with the present disclosure;

FIG. 2 illustrates the components of the cutting jig 100 of FIG. 1 in a disassembled state;

FIG. 3 is a perspective view of the cutting jig 100 of FIG. 1;

FIG. 4 is a front plan view of the cutting jig 100 of FIGS. 1 to 3;

FIG. 5 is a top perspective view of the cutting jig 100 of FIGS. 1 to 3;

FIG. 6a is a side elevational view of an embodiment of a body portion of a cutting jig in accordance with an embodiment of the present disclosure;

FIG. 6b is a side elevational view of an embodiment of a body portion of a cutting jig in accordance with an embodiment of the present disclosure, without dimensions shown;

FIG. 7a is a front view of a lower portion and a grip portion of a cutting jig;

FIG. 7b is a front view of a lower portion and a grip portion of a cutting jig, without any dimensions shown;

FIG. 8a is a side elevational view of an embodiment of a body of a cutting jig;

FIG. 8b is a side elevational view of an embodiment of body of a cutting jig, without dimensions shown

FIGS. 9a and 9b are schematic representations of different embodiments of a ruler suitable for use with a cutting jig of the present disclosure;

FIG. 10 is a cross-sectional view of the ruler of FIGS. 9a, 9b across a transverse axis;

FIG. 11 is a perspective view of a top plate of a cutting jig in accordance with an embodiment of the present disclosure;

FIG. 12a is a top plan view of the top plate 130 of FIG. 11;

FIG. 12b is a top plan view of the top plate 130 of FIG. 1, without dimensions shown;

FIG. 13 is a side plan view of the top plate 130 along the longer side of the top plate 130;

FIG. 14a is a side plan view of the top plate 130 along the shorter side of the top plate 130;

FIG. 14b is a side plan view of the top plate 130 along the shorter side of the top plate 130, without dimensions shown;

FIG. 15a is a perspective view of the lower portion 120 and grip portion 150 of FIG. 7;

FIG. 15b is a perspective view of the lower portion 120 and grip portion 150 of FIG. 7, without dimensions shown;

FIG. 16 is a perspective view showing a ruler slidably engaged in a longitudinal channel defined by apertures in a lower portion of a body of a cutting jig;

FIG. 17 is a bottom plan view of a lower portion of a body of a cutting jig;

FIG. 18 is a bottom plan view of the body 110 of FIG. 1 showing the ruler 140 slidably engaged in the lower portion 120;

FIG. 19 is a front view of a section of the ruler 140 illustrating a cavity for holding a level indicator;

FIG. 20 is a perspective view of two cutting jigs joined by a single ruler

FIG. 21 is a front plan view of the arrangement of FIG. 20, showing the ruler passing horizontally through two cutting jigs placed in a horizontal configuration.

FIG. 22 is a bottom plan view of the arrangement of FIG. 20;

FIG. 23 is a back plan view of the arrangement of FIG. 20;

FIG. 24 illustrates an arrangement in which a ruler passes through a longitudinal axis of a first cutting jig and a transverse axis of a second cutting jig;

FIG. 25 illustrates an arrangement in which a ruler passes through a transverse axis of first and second cutting jigs;

FIG. 26 is an image of a C-clip mounting plate; and

FIG. 27 is an image of a rear face of an outlet plate for a double power point.

Features in the accompanying drawings that have the same reference numerals are to be considered to have the same function(s) or operation(s), unless the contrary intention is expressed or implied.

### DETAILED DESCRIPTION

It is often advantageous functionally and/or aesthetically to locate electrical outlets at the same height, the same distance from a reference point, or a combination thereof. For example, in residential premises it is aesthetically pleasing to have multiple wall outlets (such as power points and/or switch plates) within the room all located the same height from a reference point, such as the floor or the top of skirting boards. Further, locating all wall outlets at the same height can provide functional advantages in running wires, avoiding wall framing members, and the like. Similarly, it is advantageous to locate wall outlets, such as light switches and fan controls, the same distance in from a door frame. A person entering different rooms is able to access the light switch easily if the light switches in different rooms are located the same distance from the door frame reference point.

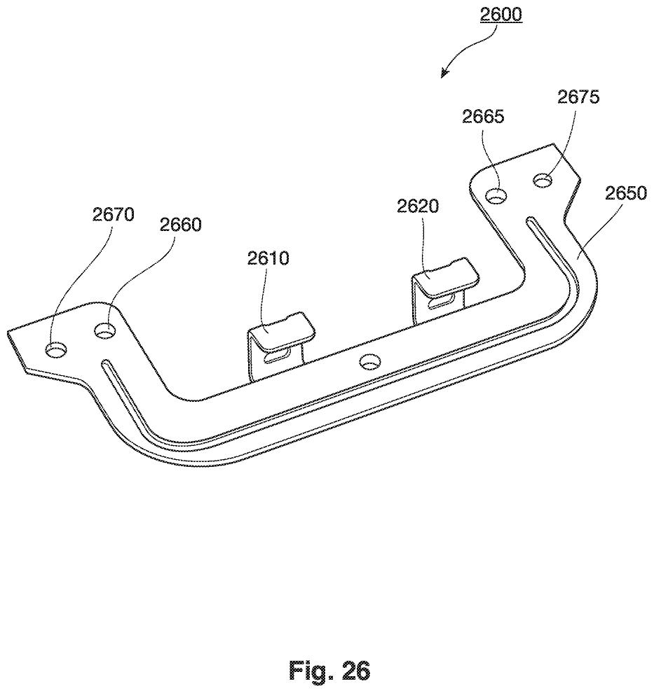

As mentioned above, when installing an electrical outlet in plasterboard, a tradesperson often utilises a mounting bracket, such as a C-clip mounting bracket, in order to provide a solid attachment point for the outlet plate. FIG. 26 is an image of a C-clip mounting plate 2600 having first and second clips 2610, 2620 for coupling the C-clip mounting plate 2600 to the plasterboard. In practice, the front of the clips 2610, 2620 are placed on the surface of the plasterboard facing the room, with the plate 2650 being located on the surface of the plasterboard facing the wall cavity. The C-clip mounting plate 2600 has a first pair of mounting holes 2660, 2665 and a second pair of mounting holes 2670, 2675. Providing two pairs of mounting holes enables the C-clip mounting plate 2600 to be used in relation to a broader range of outlet plates. In use, threaded bolts or screws are passed through an electrical outlet plate, which is larger than the electrical outlet cut into the plasterboard, and secured into mounting holes 2660, 2665 or 2670, 2675.

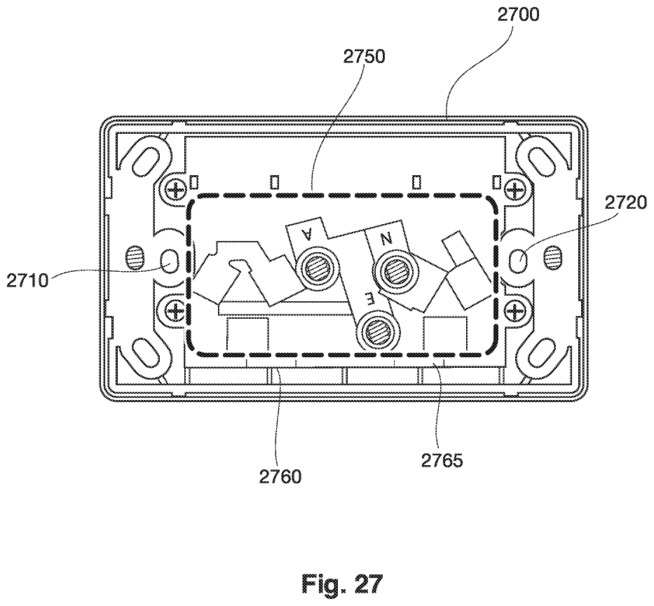

FIG. 27 is an image of a rear face of an outlet plate 2700 for a double power point. The outlet plate 2700 includes a pair of apertures 2710, 2720 through which threaded bolts or screws may pass to secure the outlet plate 2700 to a wall, such as by engaging with threaded apertures on a C-clip mounting bracket coupled to a plasterboard in an electrical outlet.

The outlet plate 2700 includes an inner region 2750, denoted by a dotted line, that contains the couplings for the electrical wires. The electrical outlet needs to be sufficiently large and of a suitable shape to receive the inner region 2750 of the outlet plate 2700. Accordingly, electrical outlets are generally rectangular or elliptical in shape to accommodate the inner region 2750 of an outlet plate and to receive a C-clip mounting bracket or similar. In the example of FIG. 27, the outlet plate 2700 includes optional indentations 2760, 2765 to align the outlet plate 2700 to receive the front of the clips 2610, 2610 of a C-clip mounting bracket 2600. It will be appreciated that any shape may be utilised for an electrical outlet, including circular, elliptical, rectangular, and the like.

The present disclosure provides an electrical outlet cutting jig that facilitates marking a position of a new electrical outlet. In particular, the cutting jig includes a ruler that is slidably engaged in a channel of a body of the cutting jig. A user can slide the ruler to provide a guide so that the cutting jig is placed a predefined distance from a reference point.

The cutting jig includes a body having a lower perimeter with dimensions that correspond substantially to the size of an electrical outlet, wherein the electrical outlet is smaller than an outlet plate to be affixed over the electrical outlet. The lower perimeter may be any shape suitable to receive the required wiring and any rear projection of the outlet plate.

In some embodiments, the lower perimeter is rectangular or substantially rectangular in shape. For example, In one implementation, the lower perimeter is rectangular with rounded corners. In other embodiments, the lower perimeter is elliptical or round. It will be appreciated that the cutting jig may include a lower perimeter of any shape suitable for an electrical outlet and that particular applications may utilise particular shapes.

In use, a user places the lower perimeter of the body against a surface on which an electrical outlet is to be marked, such as on plasterboard. The user can then use a pencil, marker pen, or suitable marking implement to mark the outline of the electrical outlet. The marking implement may include, for example, a knife or other tool with a suitable edge to score the surface. For example, the user may utilise a utility knife to trace the lower rectangular perimeter on the surface of plasterboard, thus leaving an outline of the electrical outlet in the surface. A reciprocating saw or other suitable tool can then be utilised to cut out an opening for the electrical outlet.

The cutting jig is suitable for use in marking the location of standard sized electrical outlets, such as outlets for a general purpose outlet (GPO) for mains power, a local area network (LAN) cabling plate, a light switch, a Universal Serial Bus (USB) charging port plate, a fan control plate, or the like. The size and shape of the lower perimeter of the body portion of the cutting jig may vary for different specific applications.

Various components of the cutting jig described herein may be manufactured of different materials, including plastic, rubber, metal, wood, composites, and the like. In some embodiments, blow moulded plastic is utilised for one or more components of the cutting jig. In particular implementations, the body and ruler of the cutting jig are made from thermoplastic polymers, such as polycarbonate.

The body includes a first channel defined along a first axis of the body and a ruler that is shaped to slide in the first channel such that a bottom surface of the ruler is flush, or substantially flush, with the lower perimeter of the body. When the lower perimeter of the body is pressed against the surface, the ruler is also substantially against the surface, which results in minimum flex from the ruler and thus ensures that readings taken from the ruler are accurate. In some embodiments, the ruler is marked with a set of gradations corresponding to at least one of the metric and imperial measurement systems to provide the user with a required level of precision. In one particular embodiment, the ruler is marked with centimetre and millimetre gradations.

The cutting jig is also equipped with horizontal and vertical level indicators to ensure that the cutting jig is correctly aligned and consistently aligned from one electrical outlet to another.

In some embodiments, the body includes a rectangular lower portion that has a rectangular rim defining the lower perimeter. In some embodiments, the first channel is defined by apertures in a first pair of opposing edges of the lower perimeter, which in some embodiments forms a rectangular rim. In one particular implementation, each aperture is associated with a pair of opposing resiliently deformable lugs positioned to engage the slidable ruler with friction. In other embodiments, the rectangular lower portion is a rectangular cuboid and the first channel is defined by a continuous, or substantially continuous, aperture through the lower portion. In other embodiments, the rectangular lower portion is a rectangular pyramidal frustum in shape, either as a solid body or hollow without a base. It will be appreciated that other form factors may equally be practised for the lower portion without departing from the spirit and scope of the present disclosure. Depending on the implementation, the lower rectangular portion may have squared off or rounded corners.

In some embodiments, the lugs on the body portion frictionally engage the ruler to hold the ruler in place. In alternative embodiments, the ruler includes a series of indentations adapted to be engaged by the lugs to hold the ruler at predefined positions corresponding to the positions of the indentations along the ruler. In further alternative embodiments, the body portion includes a resiliently deformable spring or clip to frictionally engage the ruler to hold the ruler in place. Alternative engagement devices may equally be practised to frictionally engage the ruler to the body portion.

In some embodiments, the first channel runs along a first axis corresponding to a longitudinal axis of the body. In some embodiments, the first channel runs along a first axis corresponding to a transverse axis of the body. In some embodiments, the cutting jig is further equipped with a second channel along a second axis of the body, such that the first axis corresponds to the longitudinal axis of the body and the second axis corresponds to the transverse axis of the body, or vice versa. That is, the first and second channels are orthogonal to each other.

The horizontal and vertical level indicators can be implemented using any suitable means. For example the level indicators may be implemented using spirit level indicators, electronic level indicators, or a combination thereof. Electronic level indicators may be implemented, for example, using a display and an associated accelerometer.

In order to improve the usability of the cutting jig, in some embodiments the body optionally includes one or more gripping elements to improve the grip of a user. The gripping elements may include, for example, one or more textured regions, concave regions, or a combination thereof. Some embodiments include a grip portion that projects above the lower portion and is suitable for holding. The grip portion optionally includes one or more gripping elements. In some implementations, the grip portion includes a substantially rectangular gripping rim projecting from an upper surface of the lower portion. The grip portion optionally includes at least one gripping element in the form of a concave cylindrical depression in the gripping rim suitable for gripping by a finger of a user. Further optionally, the grip portion includes at least one pair of opposing concave cylindrical depressions in the gripping rim, suitable for engagement by the thumb and forefinger of a user to minimise slipping while holding the cutting jig against a surface.

Further embodiments optionally include a top plate affixed to the grip portion, wherein the top plate extends beyond an upper perimeter of said grip portion and includes at least one pair of opposing gripping elements. In some implementations, the top plate includes at least one pair of concave cut-outs along an axis of the top plate. In particular implementations, the top plate is substantially rectangular and a first pair of concave cut-outs is placed on a longitudinal axis of the top plate and a second pair of concave cut-outs is placed on a transverse axis of the top plate. Providing multiple pairs of gripping elements along multiple axes enables a user to hold the cutting jig securely in any orientation.

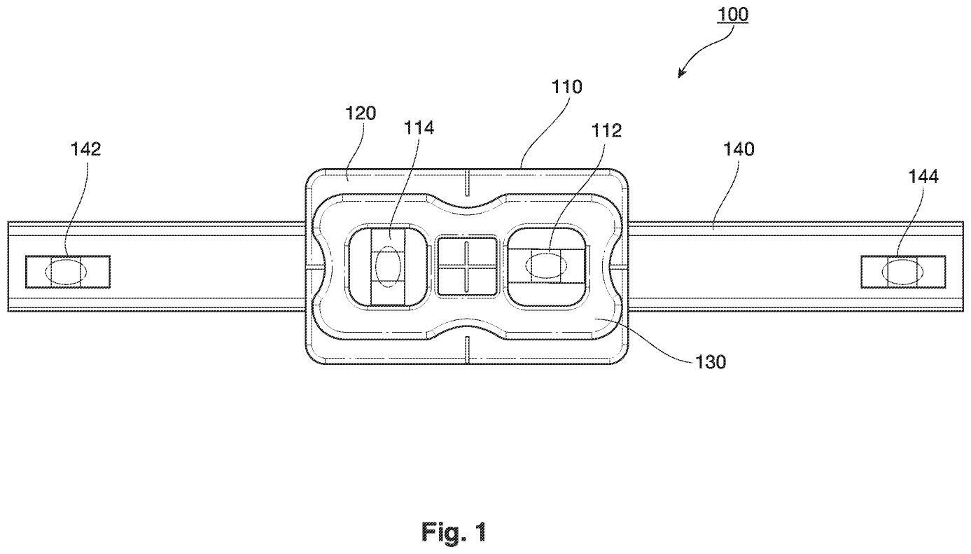

FIG. 1 illustrates an embodiment of an electrical outlet cutting jig 100 in accordance with the present disclosure. The cutting jig 100 includes a body 110 that includes a rectangular lower portion 120 and a top plate 130. The rectangular lower portion has a substantially rectangular rim defining a lower rectangular perimeter at the bottom of the body 110. In some embodiments, such as that shown in FIG. 1, the lower rectangular perimeter optionally has rounded corners. The body 110 also has a top plate 130, a horizontal level indicator 150 and a vertical level indicator 160. The top plate 130 has a plurality of gripping elements in the form of concave cut-outs along the perimeter of the top plate 130. In particular, opposing pairs of cut-outs, suitable for being held by fingers of a user, are placed along the longitudinal axis and transverse axis of the body 110.

As described above, the lower perimeter is suitably dimensioned for the electrical outlet to be installed. In the example of FIG. 1 in which the body includes a lower rectangular perimeter, the lower perimeter may have a length in the range of 50 mm to 300 mm and a width in the range of 20 mm to 300 mm. In some embodiments, the lower perimeter has a length in the range of 75 mm to 150 mm and a width in the range of 75 mm to 150 mm. In the example of FIG. 1, the lower perimeter has a length of 87 mm and a width of 52 mm, which is suitable for receiving wiring associated with a standard electrical outlet wall plate.

In another example, an electrical plate for a double general purpose outlet suitable for use in European installations has a length of 150 mm and a width of 80 mm. A cutting jig in accordance with the present disclosure and sized for such a double general purpose outlet may have, for example, a length in the range of 80 mm to 140 mm and a width in the range of 20 to 70 mm. Particular embodiments may have lengths in the range of 100 mm to 120 mm and widths in the range of 40 mm to 60 mm. In a further example, a plate for a single electrical outlet suitable for use in US installations has a length of 80 mm and a width of 80 mm. A cutting jig in accordance with the present disclosure and sized for such a single electrical outlet may have, for example, a length in the range of 20 mm to 50 mm and a width in the range of 20 mm to 50 mm. It will be appreciated that other dimensions and shapes (e.g., circles, triangles, or other polygons) may equally be practised to suit the size and shape of the electrical outlet to be installed. For example, a lower perimeter may be circular with a diameter in the range of 50 mm to 150 mm.

The cutting jig 100 also includes a ruler 140 that slidably engages with the body 110. In the example of FIG. 1, the ruler 140 passes through a channel defined in the lower portion 120. In the example of FIG. 1, the ruler 140 includes optional horizontal ruler level indicators 142, 144. The horizontal ruler level indicators 142, 144 provide guidance to a user to ensure that the cutting jig 100 is correctly aligned when marking a position of an electrical outlet. The body 110 of FIG. 1 also includes a horizontal level indicator 112 and a vertical level indicator 114. Again, the horizontal level indicator 112 and vertical level indicator 114 provide guidance to a user to ensure that the cutting jig is correctly aligned when marking a position of an electrical outlet.

Whilst the level indicators 142, 144, 112, 114 are described as being horizontal or vertical with reference to the illustration of FIG. 1, it will be appreciated that the cutting jig in use can be rotated through 90 degrees to mark an electrical outlet in a vertical orientation. When the cutting jig is rotated about 90 degrees, the horizontal level indicators 112, 142, 144 become vertical level indicators and the vertical level indicator 114 becomes a horizontal level indicator.

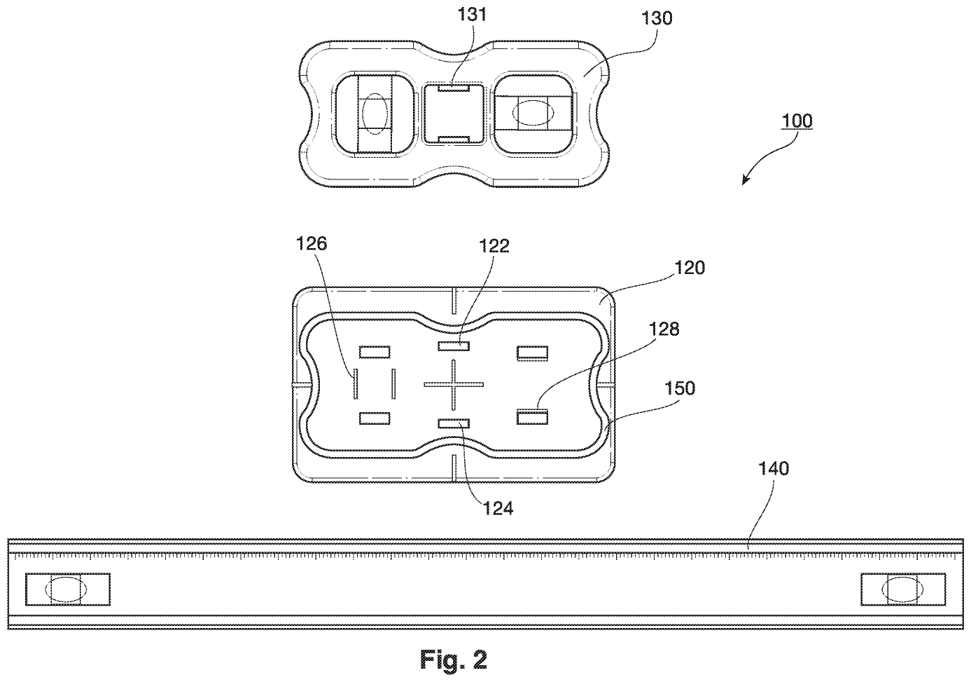

FIG. 2 illustrates the components of an embodiment of the cutting jig 100 in a disassembled state. In this particular embodiment, the body 110 is formed of a lower portion 120 joined to a grip portion 150. In this embodiment, the grip portion 150 includes a substantially rectangular rim, with rounded corners, projecting from an upper surface of the lower portion 120.

The top plate 130 has lugs 131 that are configured to engage with slots 122, 124 in the upper surface of the lower portion 120, so that when assembled the lugs secure the top plate 130 to abut against an upper surface of the rectangular rim of the grip portion 150. In alternative embodiments, the top plate 130 is integrally formed with the grip portion 150. In some embodiments, the outer perimeter of the top plate 130 projects beyond the perimeter of the grip portion 150, such that the projecting rim formed by the top plate 130 over the grip portion 150 provides for more secure handling of the cutting jig 100. In other embodiments, the outer perimeter of the top plate 130 is flush with the perimeter of the grip portion 150. The lower portion also has optional cradles 126, 128 to secure the vertical and horizontal level indicators 112, 114, which in this embodiment are implemented utilising spirit levels.

As can be seen from FIG. 2, the substantially rectangular rim of the grip portion 150 has a plurality of gripping elements in the form of concave cylindrical depressions. In the example of FIGS. 1 to 3, the concave cylindrical depressions are presented as opposing pairs along the longitudinal and transverse axes of the body 110. An outer perimeter of the top plate 130 has corresponding concave gripping elements to match up with the concave cylindrical depressions in the grip portion 150.

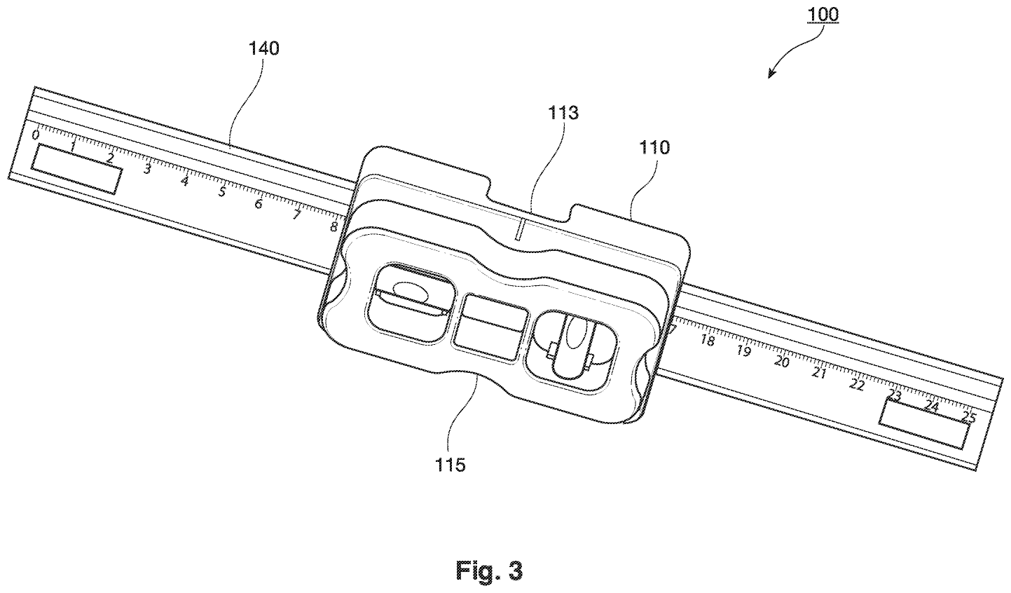

FIG. 3 is a perspective view of the cutting jig 100. The ruler 140 has gradations to assist with locating the cutting jig in the correct position. In this embodiment, the ruler 140 has gradations marked in centimetres and millimetres.

In this embodiment, the body 110 has a plurality of channels defined that are capable of receiving the ruler. As illustrated in FIGS. 1 to 3, the ruler is slidably engaged in a first channel defined along a first axis of the body 110. In this particular embodiment, the first channel is defined by apertures in a first pair of opposing edges of the rectangular rim of the lower portion 120, along a longitudinal axis of the body 110.

FIG. 3 shows an aperture 113 in the rectangular rim of the lower portion 120, which, along with a matching aperture 115 on an opposing side of the rectangular rim of the lower portion 120, defines a second channel along a transverse axis of the body 110. Providing two orthogonal channels enables the slidable ruler to be used along either the longitudinal axis or the transverse axis of the body 110, depending on the requirements of the user. Further, the user can utilise the ruler 140 along a first axis to position the body portion in one direction and then move the ruler to a second axis to position the body portion in an orthogonal direction.

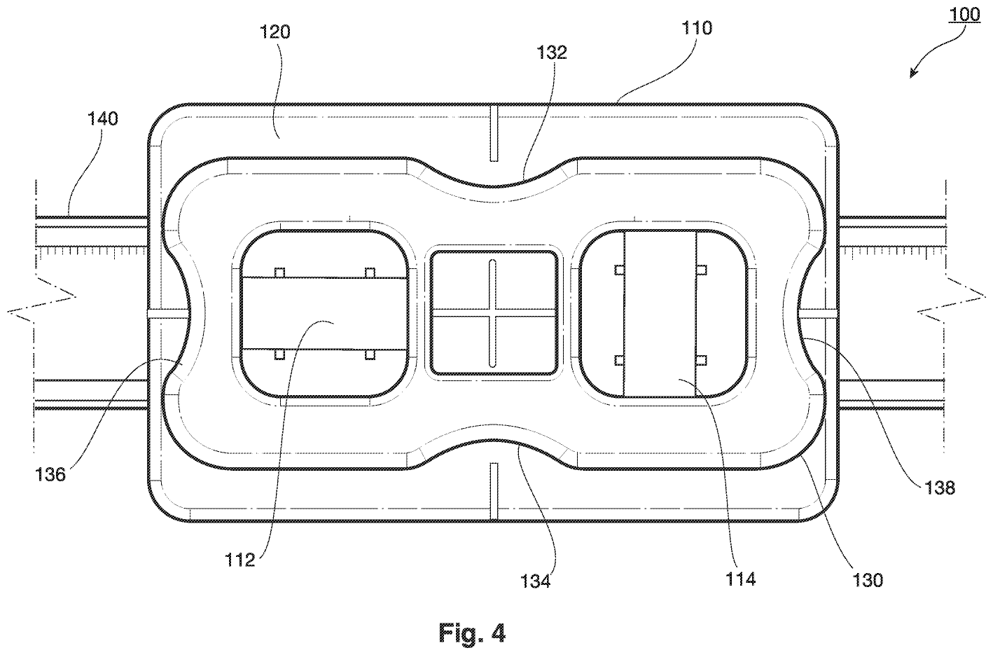

FIG. 4 is a front plan view of the cutting jig 100 of FIGS. 1 to 3, with the positions of the horizontal level indicator 112 and the vertical level indicator 114 reversed, indicating that either arrangement is possible. In this example, the ruler 140 is slidably engaged with a first channel defined in the body 110 along a longitudinal axis of the body 110. The top plate 130 has a first pair of opposing gripping elements 132, 134 along a transverse axis of the body 110 and a second pair of opposing gripping elements 136, 138 along a longitudinal axis of the body 110.

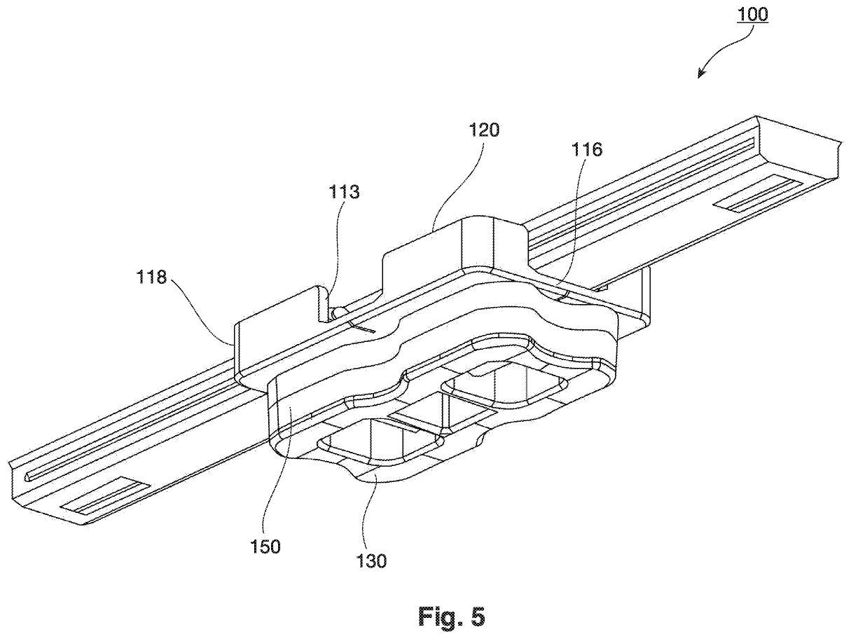

FIG. 5 is a top perspective view of the cutting jig 100, showing the ruler 140 slidably engaged in the first channel defined by apertures 116, 118 in opposing edges of a the rectangular rim of the lower portion 120. The apertures are positioned such that a bottom surface of the ruler, when engaged in the channel, is substantially flush with the bottom edge of the lower portion 120. This ensures that measurements taken using the ruler 140 are accurate.

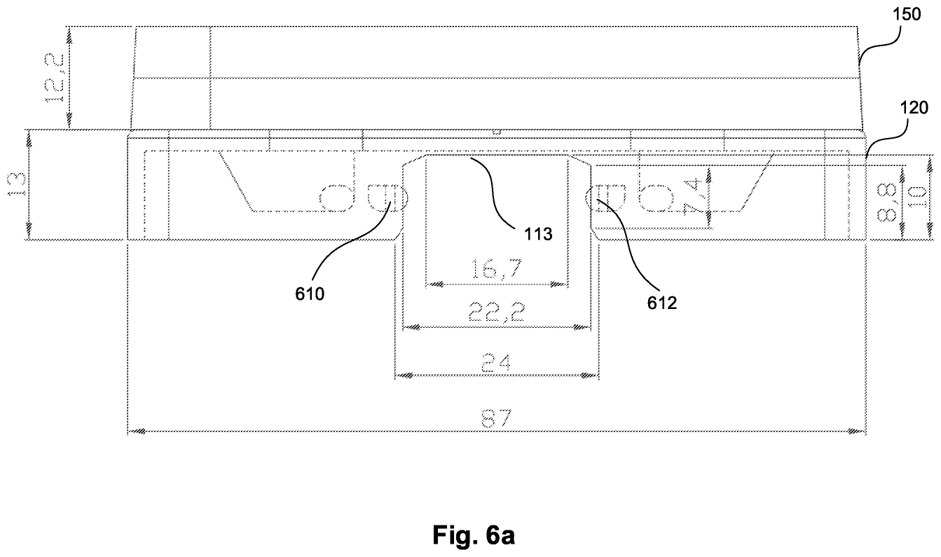

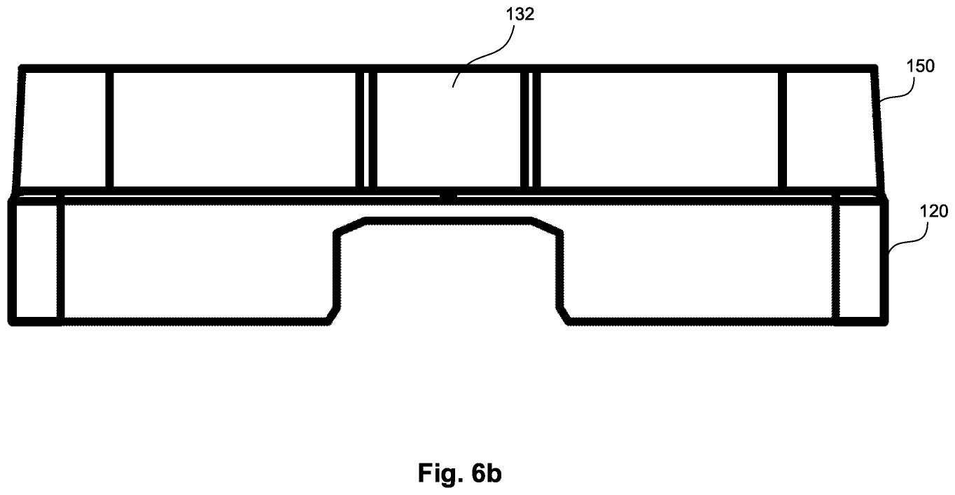

FIG. 6a is a side elevational view of an embodiment of the body 110 that includes the lower portion 120 and the grip portion 150, as seen from the longer side of the body 110. In this arrangement, the grip portion 150 has a slightly tapered configuration, from a broader base to a slightly narrower top. Other configurations without tapering (i.e., a grip portion with vertical or substantially vertical sides) may equally be practised.

In the example of FIG. 6a, the lower portion 120 has a length of 87 mm and has a rectangular rim that is 13 mm in height. An aperture 113 formed in the rectangular rim of the lower portion 120 has a bevelled lower edge and is shaped to receive the ruler 140. It will be appreciated that the shape of the aperture 113 may vary depending on the shape and dimensions of the ruler being used. Consequently, the aperture 113 may take many forms, with and without the bevelled lower edges. In the example of FIG. 6, the aperture 113 has an optional bevelled lower edge and optional bevelled upper corners to facilitate the movement of the ruler through the aperture, thus minimising wear and tear on the ruler and the lower portion.

The aperture 113 is associated with a pair of resiliently deformable lugs 610, 612 positioned on an inner surface of the rectangular rim of the lower portion 120. The lugs 610, 612 are configured to engage the ruler 140 when placed through a channel defined by the aperture 113 and a corresponding aperture on an opposing side of the rectangular rim of the lower portion 120, wherein the engagement is sufficient to hold the ruler 140 in a position selected by the user whilst allowing the user to slide the ruler 140 to another selected position.

The grip portion 150 has a substantially rectangular rim projecting from an upper surface of the lower portion 120. In this particular embodiment, the rectangular rim of the grip portion 150 tapers inwardly slightly from bottom to top.

FIG. 6b is a side elevational view of an embodiment of the body 110 that includes the lower portion 120 and the grip portion 150, as seen from the longer side of the body 110, without dimensions shown. In the example of FIG. 6b, the grip portion 150 includes an optional gripping portion 132 in the form of a vertical concave cylindrical depression.

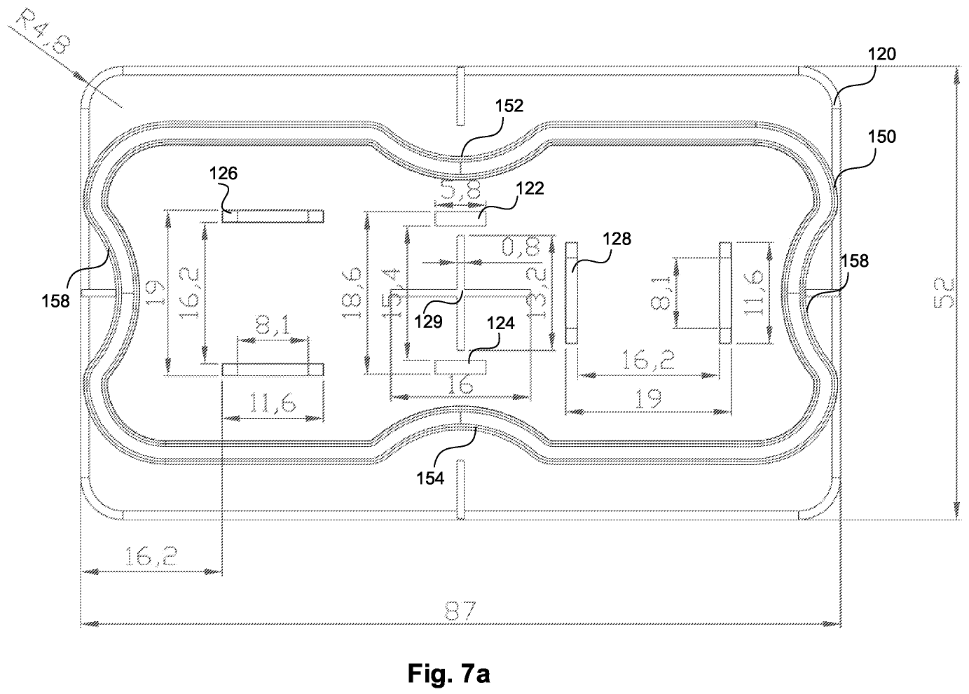

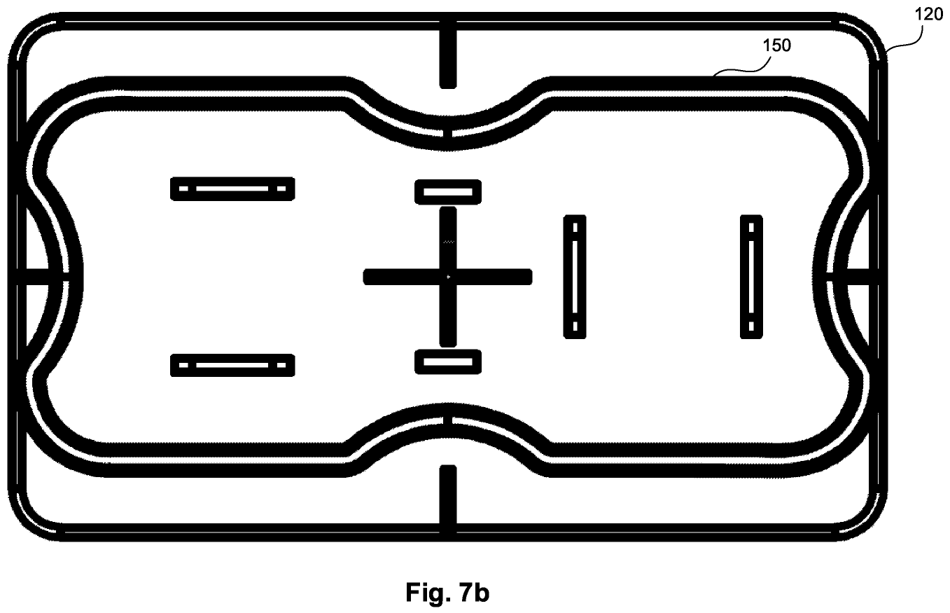

FIG. 7a is a front view of the lower portion 120 and grip portion 150. The lower portion 120 is substantially rectangular in shape, optionally having rounded corners. In this example, the lower portion is 87 mm long and 52 mm wide, corresponding to the size of a hole to be cut for an electrical outlet. An upper surface of the lower portion 120 has slots 122, 124 to receive lugs 131 from an optional top plate 130 to secure the top plate to the lower portion 120.

The grip portion 150 has cradles 126 and 128 to hold the vertical and horizontal level indicators 114, 112, respectively. In this embodiment, the substantially rectangular rim of the grip portion 150 has a plurality of gripping elements in the form of concave cylindrical depressions 152, 154, 156, 158. Gripping elements 152, 154 are aligned along a transverse axis of the body 110 and gripping elements 156, 158 are aligned along a longitudinal axis of the body 110. It will be appreciated the more or fewer gripping elements may be utilised, depending on the implementation. For example, some embodiments utilise a textured surface around some or all of the substantially rectangular rim of the grip portion 150 to aid in secure handling of the body 110.

In the example of FIG. 7a, the lower portion 120 includes an optional cross-hair marking 129 in the middle of the lower portion 120. The cross-hair marking 129 enables a user to identify the centre of the cutting jig. It will be appreciated that the marking 129 may take different forms, such as a single horizontal or vertical line, a square, circle, or other shape, that enables the user to identify the centre of the cutting jig.

FIG. 7b is a front view of the lower portion 120 and grip portion 150, without any dimensions shown. As there is no standard for electrical outlet holes, the dimensions of the cutting jig may vary. Further, the shape of the perimeter of the lower portion 120 may vary, depending on the type of electrical outlet for which the cutting jig is to be utilised, and may include, for example, round and elliptical perimeters.

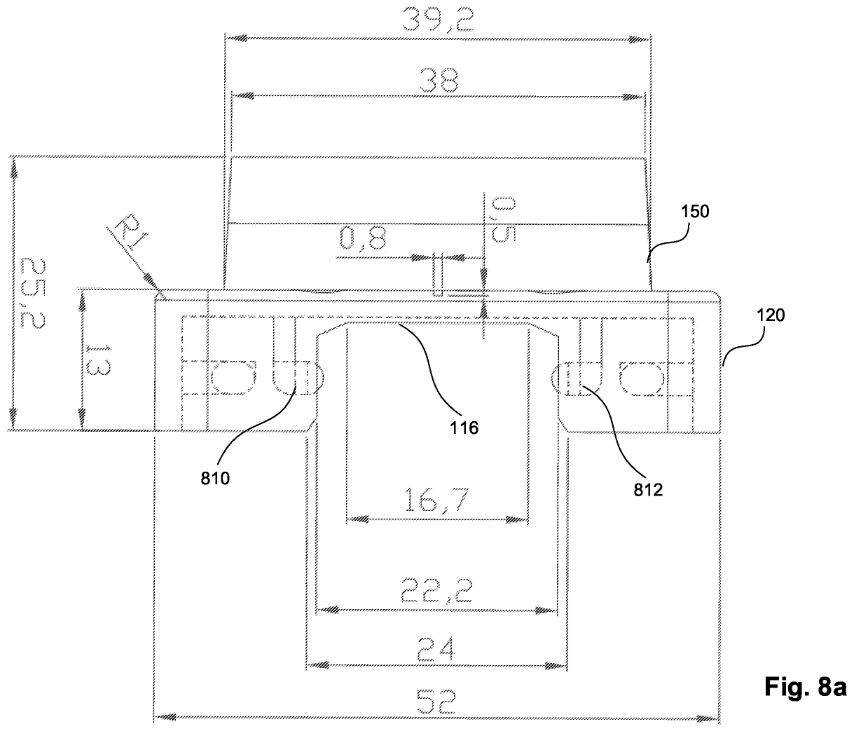

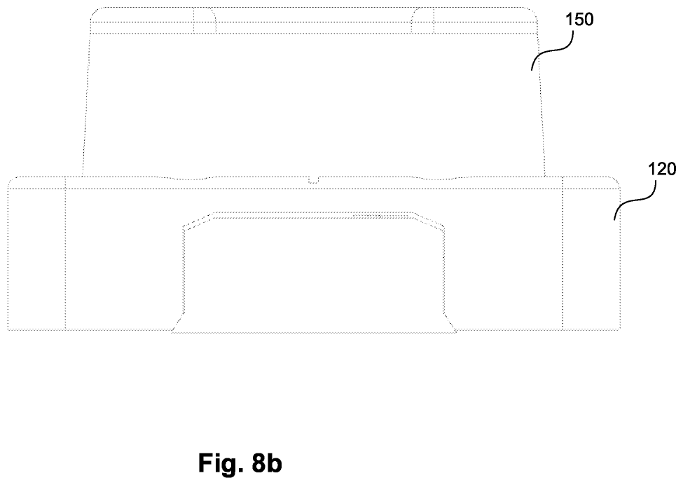

FIG. 8a is a side elevational view of an embodiment of the body 110 that includes the lower portion 120 and the grip portion 150, as seen from the shorter side of the body 110. In the example of FIG. 8a, the lower portion 120 has a width of 52 mm and has a rectangular rim that is 13 mm in height. An aperture 116 formed in the rectangular rim of the lower portion 120 has a bevelled lower edge and is shaped to receive the ruler 140.

The aperture 116 is associated with a pair of resiliently deformable lugs 810, 812 positioned on an inner surface of the rectangular rim of the lower portion 120. The lugs 810, 812 are configured to engage the ruler 140 when placed in a channel defined by the aperture 116 and a corresponding aperture 118 on an opposing side of the rectangular rim of the lower portion 120, wherein the engagement is sufficient to hold the ruler 140 in a position selected by the user whilst allowing the user to slide the ruler 140 to another selected position.

The grip portion 150 has a substantially rectangular rim projecting from an upper surface of the lower portion 120. In this particular embodiment, the rectangular rim of the grip portion 150 tapers inwardly slightly from bottom to top.

FIG. 8b is a side elevational view of an embodiment of the body 110 that includes the lower portion 120 and the grip portion 150, as seen from the shorter side of the body 110, without dimensions shown.

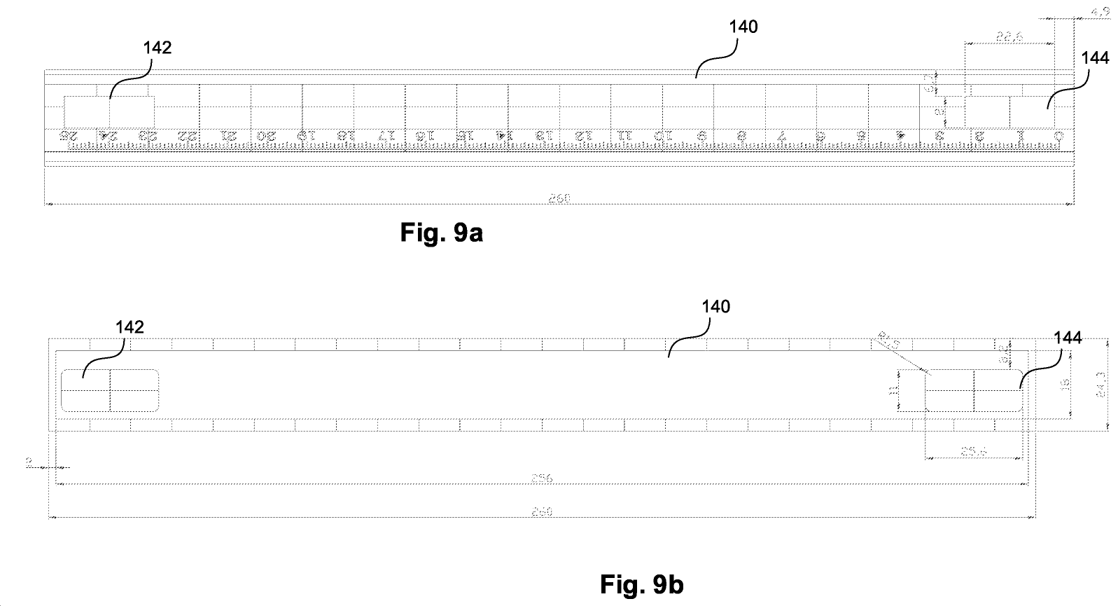

FIGS. 9a and 9b are schematic representations of different embodiments of the ruler 140, each of which has a pair of optional level indicators 142, 144. Depending on the orientation of the ruler 140, the level indicators 142, 144 provide a user with an indication of whether the ruler is correctly aligned about a horizontal or vertical axis. In FIG. 9a, the ruler 140 has marked gradations for centimetres and millimetres. The ruler 140 of FIG. 9b has marked gradations for centimetres, but has no numbering. Whilst the ruler 140 of FIGS. 9a and 9b is shown with certain dimensions, it will be appreciated that these dimensions relate to a single embodiment and a ruler with other dimensions suitable for engagement with the body portion of the cutting jig may equally be practised.

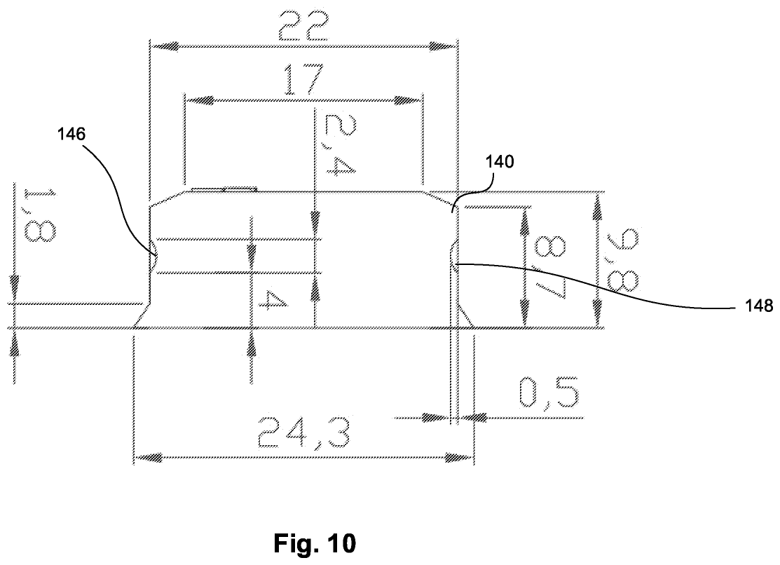

FIG. 10 is a cross-sectional view of the ruler 140 across a transverse axis. The ruler 140 in this example has a generally rectangular cross-section with bevelled edges from side surfaces to a top surface of the ruler 140. The ruler 140 has a bottom that is optionally flared to be slightly wider than the rest of the ruler. Opposing sides to the ruler have corresponding grooves 146, 148 configured to receive the lugs 610, 612 or 810, 812 when the ruler 140 is inserted into either one of the channels defined by the apertures 113, 115, 116, 118. The lugs 113, 115, 116, 118 are resiliently deformable to frictionally engage the grooves 146, 148 of the ruler 140. The frictional engagement allows a user to slide the ruler 140 along a channel of the body 110 so that a selected portion of the ruler is showing, thus allowing the body of the cutting jig to be positioned a predefined distance from a reference point.

The grooves 146, 148 are positioned on opposing sides of the ruler 140. In some embodiments, the grooves 146, 148 are concave indentations into which the lugs 113, 115, 116, 118 fit. In other embodiments, the grooves 146, 148 are convex projections that engage with the lugs 113, 115, 116, 118. In other embodiments, the opposing grooves 146, 148 utilise a combination of a concave indentation on one side of the ruler 140 and a convex projection on the other side of the ruler 140. Such an arrangement may be utilised such that the ruler 140 can only slide through a channel of the cutting jig in a particular orientation, such that any markings or gradations are the right way up. The grooves 146, 148 optionally include one or more spaced indentations to enable the lugs 113, 115, 116, 118 to engage the ruler 140 at predefined stopping intervals corresponding to the locations of the indentations.

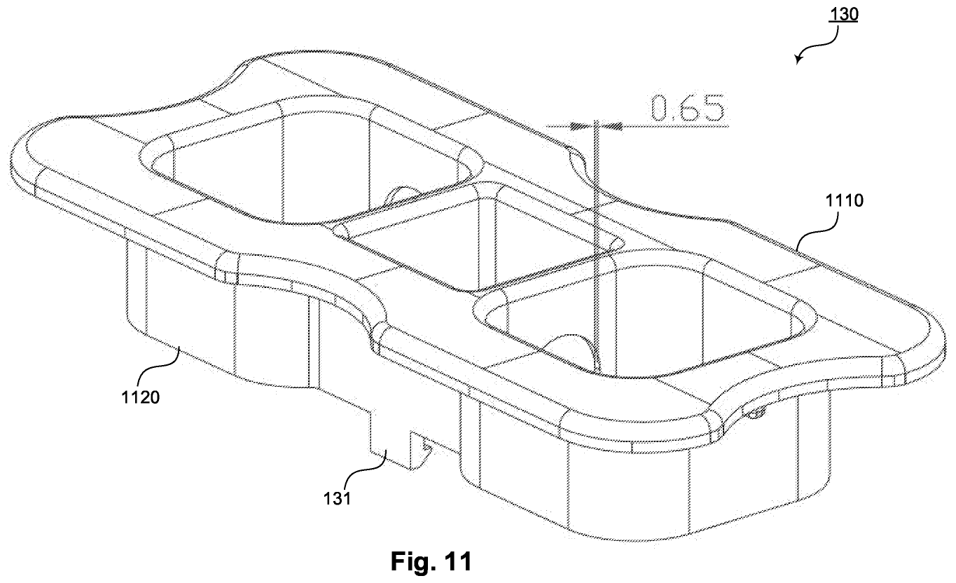

FIG. 11 is a perspective view of the top plate 130. In the example of FIG. 11, the top plate 130 includes an upper surface 1110 that, when coupled to the grip portion 150 and lower portion 120 of FIG. 7, abuts a top edge of the rectangular perimeter of the grip portion 150. The top plate 130 includes a lower flange that, when coupled to the grip portion 150 and lower portion 120, abuts an inner surface of the rectangular perimeter of the grip portion 150. The top plate 130 also includes at least one lug 131 that is configured to engage with one of the slots 122, 124 to secure the top plate 130 to the lower portion 120. In the example of FIG. 11, a wall thickness is indicated as being 0.65 mm. Other thicknesses may equally be practised, depending on the dimensions of the top plate 130, the lower portion 120, and the material utilised.

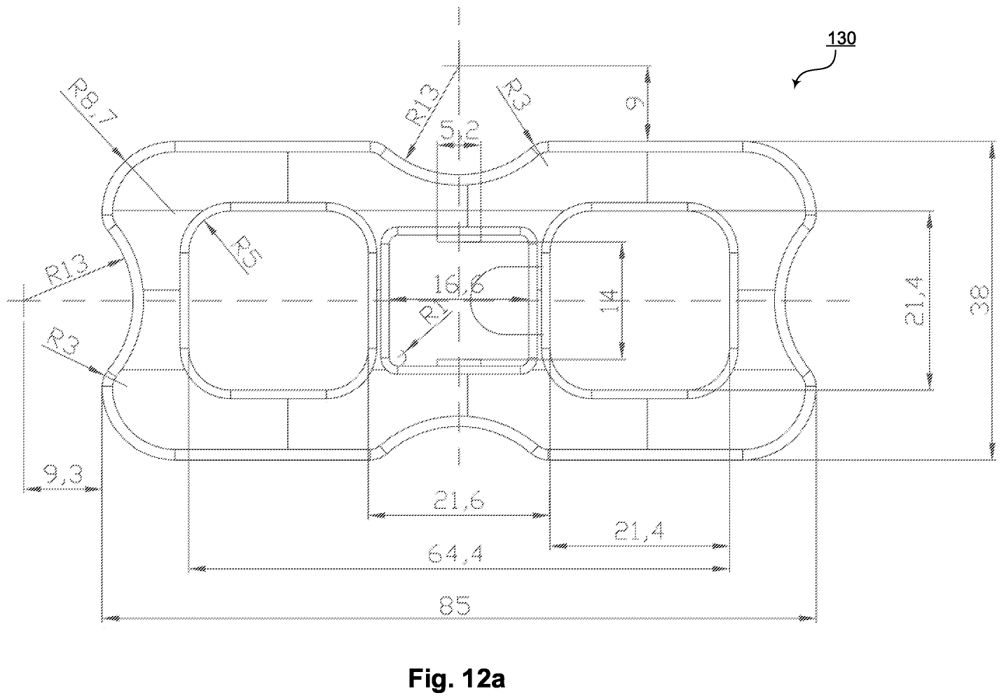

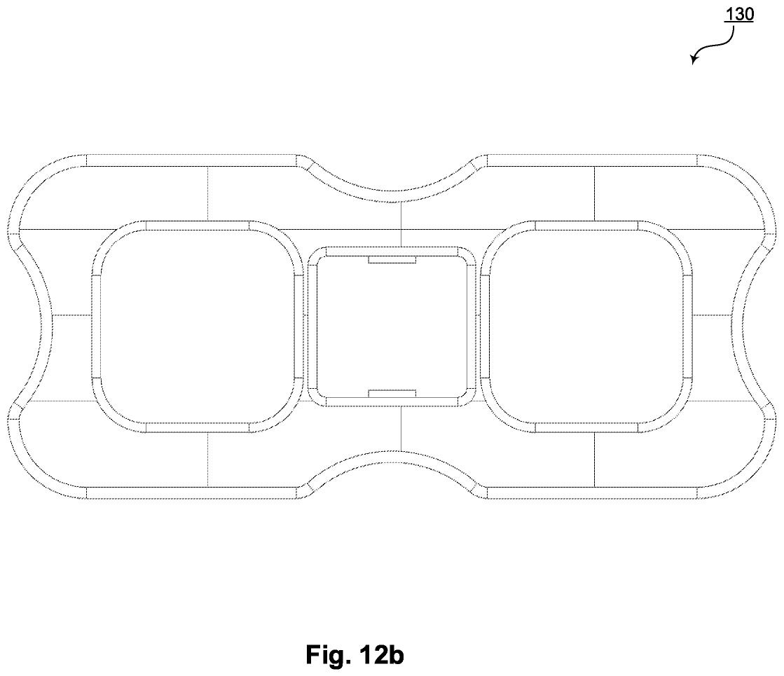

FIG. 12a is a top plan view of the top plate 130 of FIG. 11. FIG. 12b is a top plan view of the top plate 130 of FIG. 11, without dimensions shown.

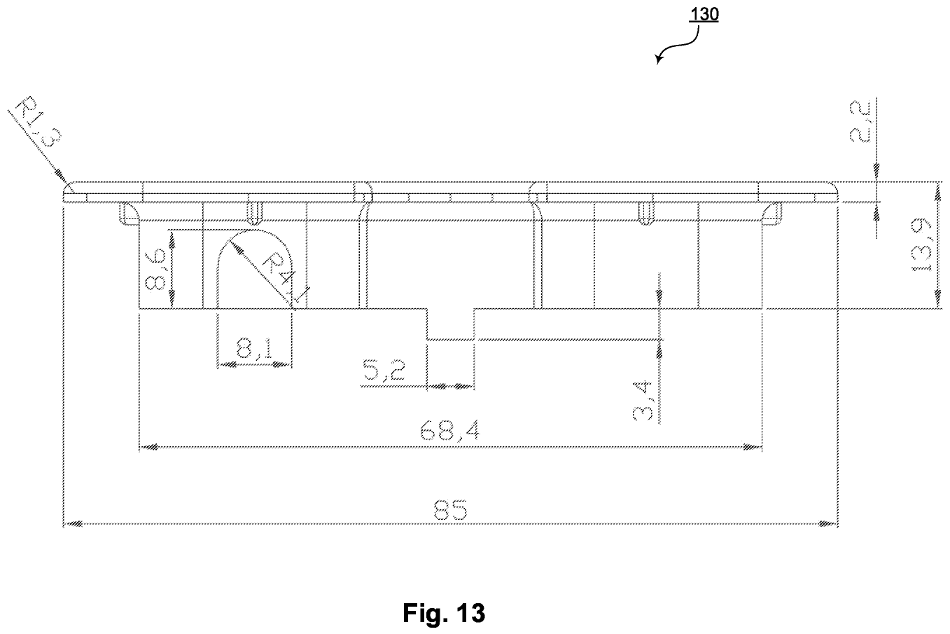

FIG. 13 is a side plan view of the top plate 130 along the longer side of the top plate 130.

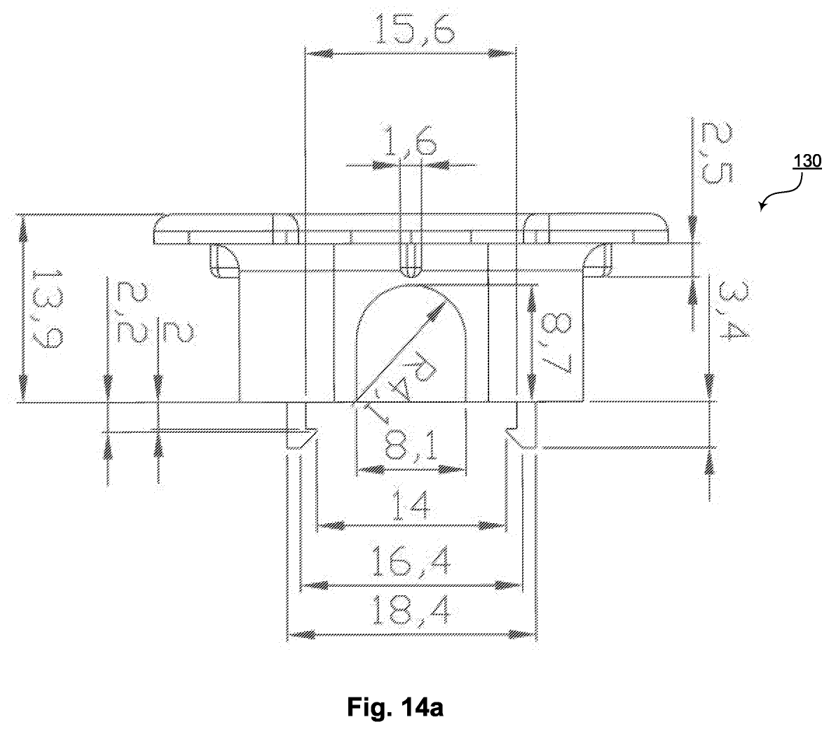

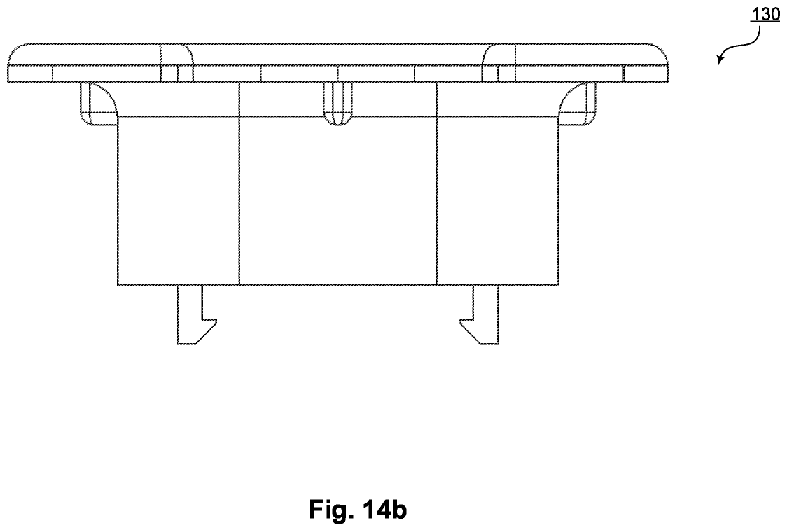

FIG. 14a is a side plan view of the top plate 130 along the shorter side of the top plate 130. FIG. 14b is a side plan view of the top plate 130 along the shorter side of the top plate 130, without dimensions shown.

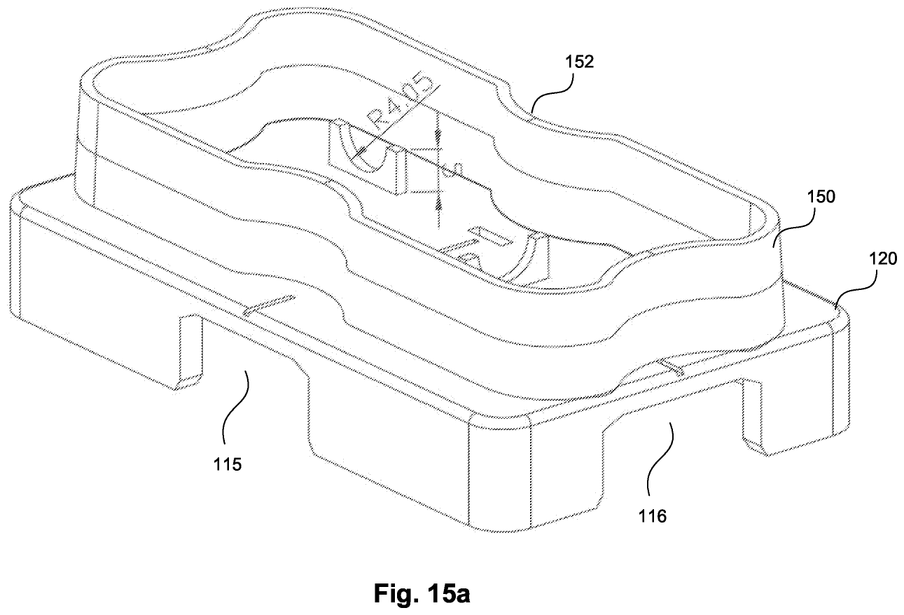

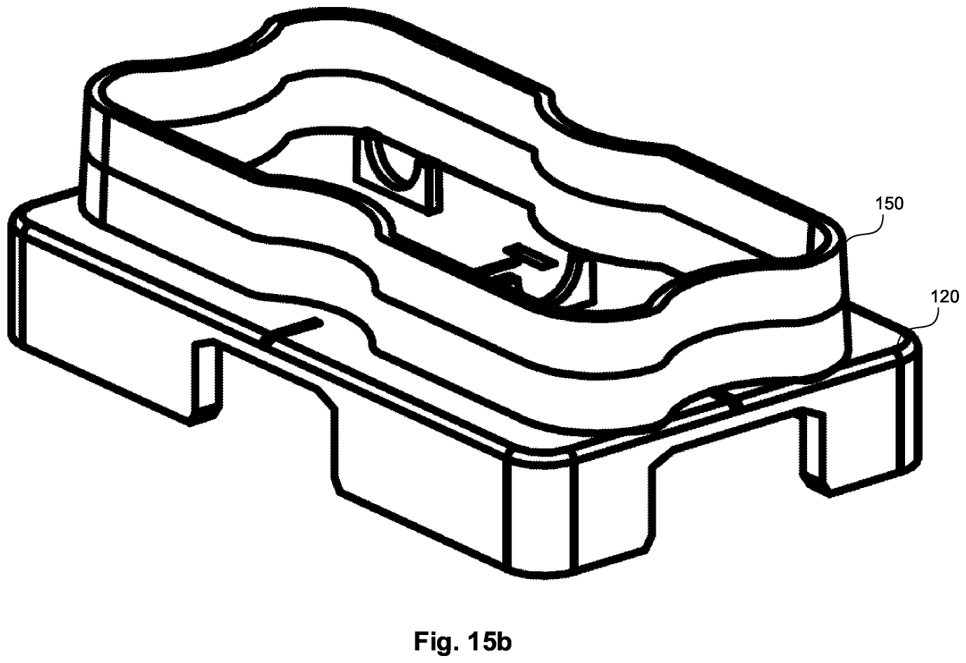

FIG. 15a is a perspective view of the lower portion 120 and grip portion 150 of FIG. 7. FIG. 15b is a perspective view of the lower portion 120 and grip portion 150, without dimensions shown.

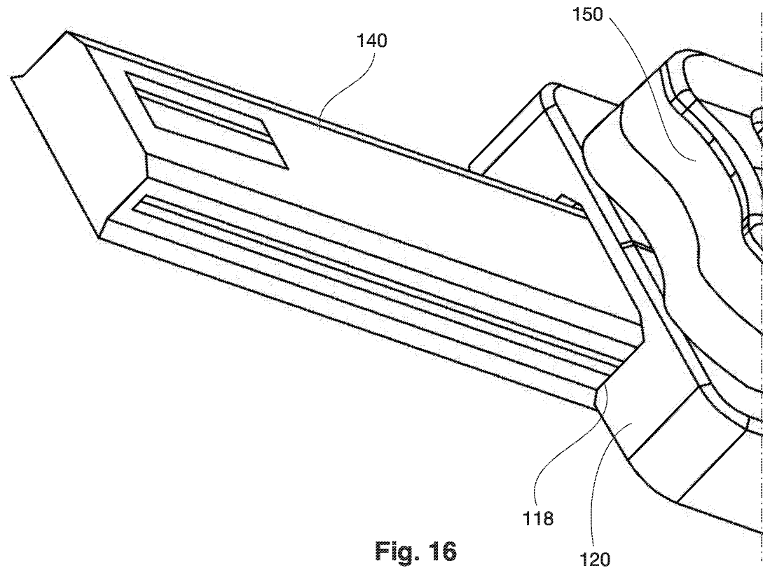

FIG. 16 is a perspective view showing the ruler 140 slidably engaged in a longitudinal channel defined by the apertures 118 and 116 in the lower portion 120 of the body 110.

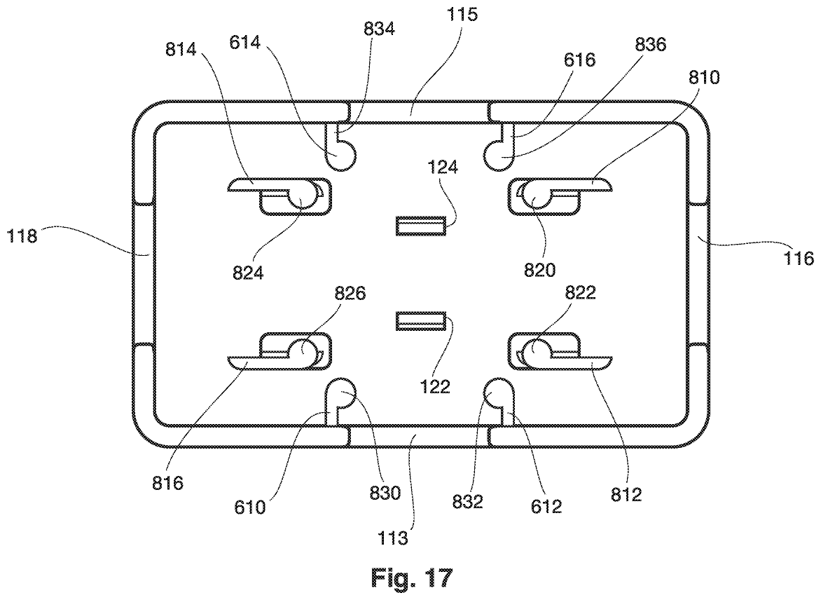

FIG. 17 is a bottom plan view of a lower portion 120 of the body 110 in accordance with an embodiment of the present disclosure. In this embodiment, the lower portion has a substantially rectangular rim with a first pair of opposing apertures 116, 118 along a longitudinal axis of the body 110 and a second pair of opposing apertures 113, 115 along a transverse axis of the body 110.

Each aperture 113, 115, 116, 118 is associated with a pair of resiliently deformable lugs configured to engage the grooves 146, 148 of the ruler 140. The aperture 113 has associated lugs 610, 612. The aperture 115 has associated lugs 614, 616. The aperture 116 has associated lugs 810, 812. The aperture 118 has associated lugs 814, 816. In the example of FIG. 17, each lug 610, 612, 614, 616, 810, 812, 814, 816 is integrally formed with an upper surface of the lower portion 120 and is resiliently deformable. Further, each lug 610, 612, 614, 616, 810, 812, 814, 816 has an inwardly facing flange configured to engage the grooves 146, 148 of the ruler 140. In particular, lug 610 has a flange 830, lug 612 has a flange 832, lug 614 has a flange 834, lug 616 has a flange 836, lug 810 has a flange 820, lug 812 has a flange 822, lug 814 has a flange 824 and lug 816 has a flange 826.

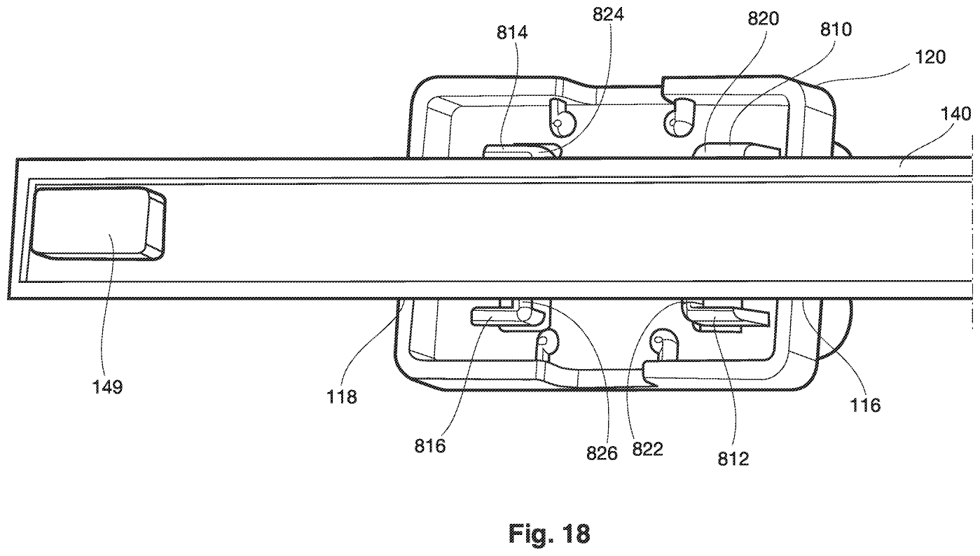

FIG. 18 is a bottom plan view of the body 110 showing the ruler 140 slidably engaged in the lower portion 120. In particular, the ruler 140 is engaged in a longitudinal channel defined by apertures 116 and 118. The lugs 810, 812, 814, 816 frictionally engage the sides of the ruler 140 by virtue of the respective flanges 820, 822, 824, and 826 frictionally engaging the grooves 146, 148 of the ruler 140.

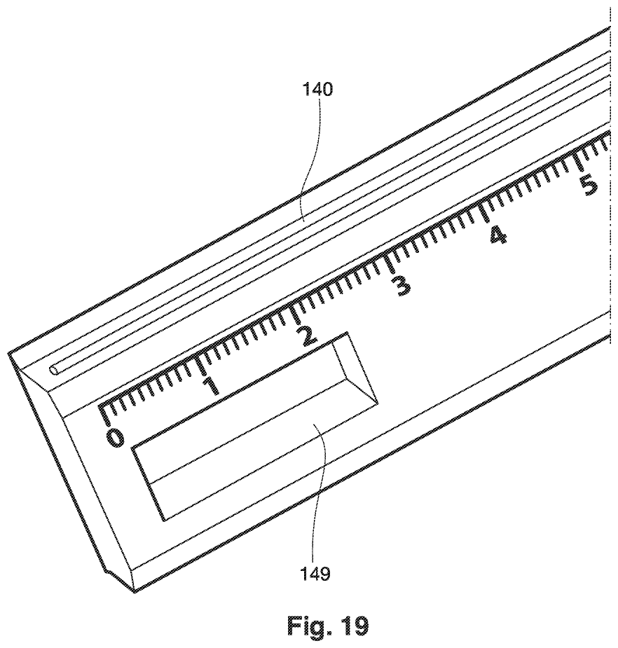

The ruler 140 in FIG. 18 includes a cavity 149 for housing a level indicator. FIG. 19 is a front view of a section of the ruler 140 illustrating the cavity 149.

The cutting jig of the present disclosure provides a ruler that is configured to pass through a channel of a body, wherein the ruler facilitates accurate placement of the body to enable a user to trace the perimeter of the body to designate where to cut a hole for an electrical outlet. In an optional embodiment, the ruler can be threaded through the channels of two or more bodies to enable a user to align multiple electrical outlets simultaneously.

In such an embodiment, the bodies may be aligned along the same axis or may be rotated relative to each other. For example, to install two GPO sockets, the user inserts the ruler through the channels defined along the longitudinal axes of two bodies. The user can utilise the ruler to ensure that the bodies are placed a selected distance apart from each other. In another example, a user wanting to install a vertical fan switch panel adjacent to a horizontal light switch panel inserts the ruler through a channel on a transverse axis of a first body and through a channel on a longitudinal axis of a second body.

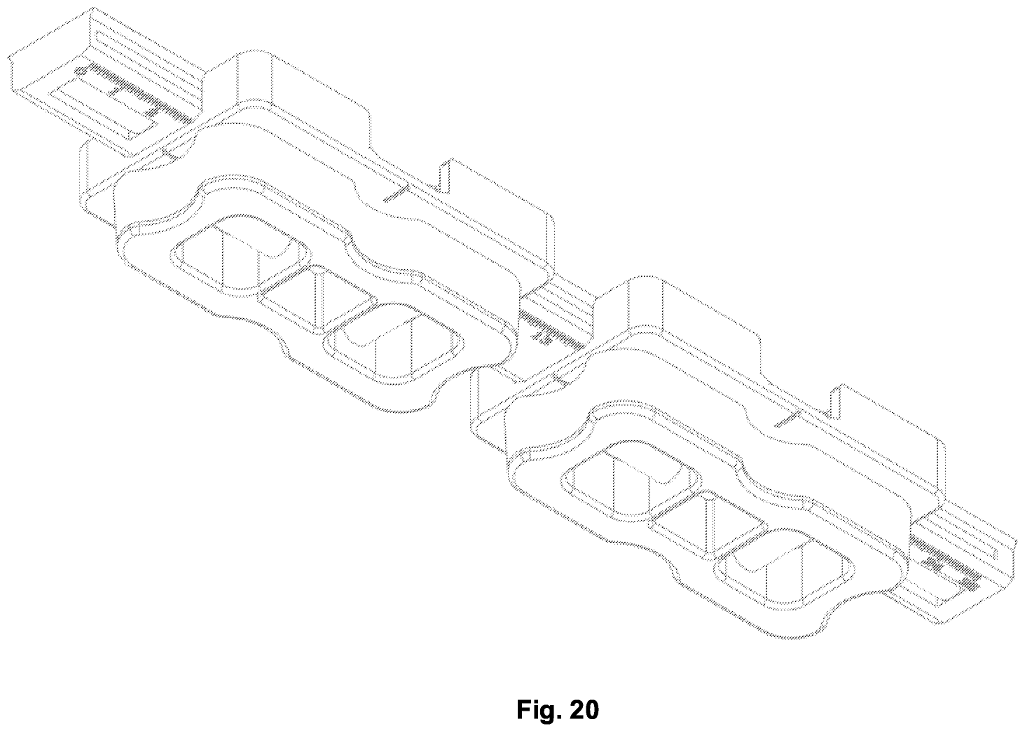

FIG. 20 is a top perspective view of two cutting jigs joined by a single ruler. Such an arrangement enables a user to mark the position of two electrical outlets in an accurate and easy manner. Further, the spacing of the two electrical outlets can be consistently applied at different positions throughout a location, yielding an efficient and aesthetically pleasing installation of electrical outlets. Efficiencies may result due to consistent placement of the outlets for the running of electrical wires and cabling, such as power wires, network cables, and the like.

In the example of FIG. 20, the ruler includes a set of gradations to provide accurate placement of the cutting jigs with respect to each other and with respect to an external reference point, such as a wall, door frame, skirting board, moulding, or the like. In the example of FIG. 20, the ruler runs horizontally through the cutting jigs. It is self-evident that the arrangement can be rotated through 90 degrees to enable a user to mark two electrical outlets in a vertical orientation and displaced from each other vertically. Such a vertical orientation may be applicable for light switches, dimmer switches, electrical outlets, network cable outlets, or the like.

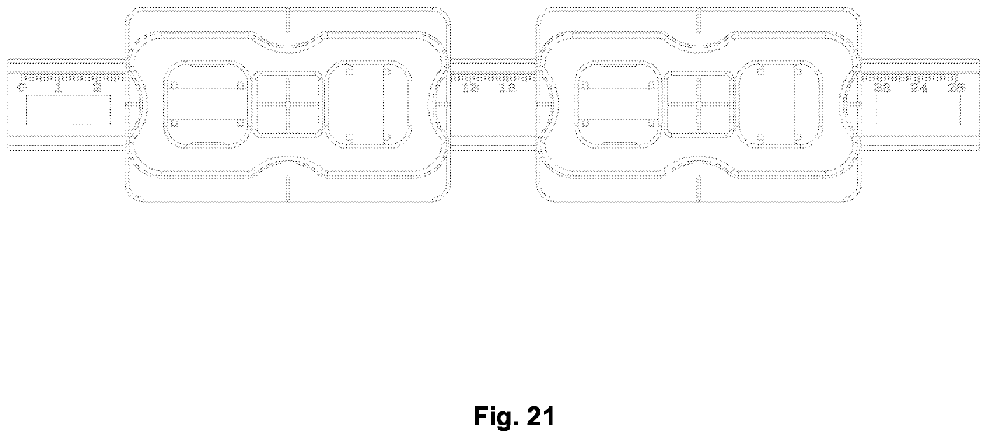

FIG. 21 is a front plan view of the arrangement of FIG. 20, showing the ruler passing horizontally through two cutting jigs placed in a horizontal configuration.

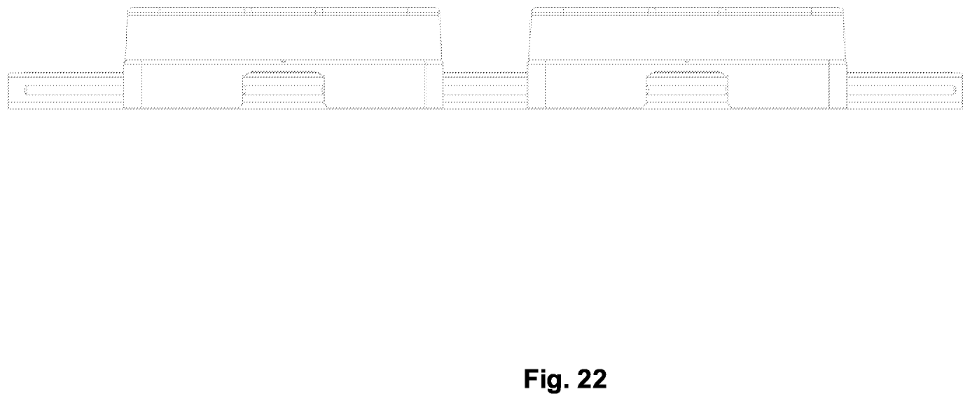

FIG. 22 is a bottom plan view of the arrangement of FIG. 20.

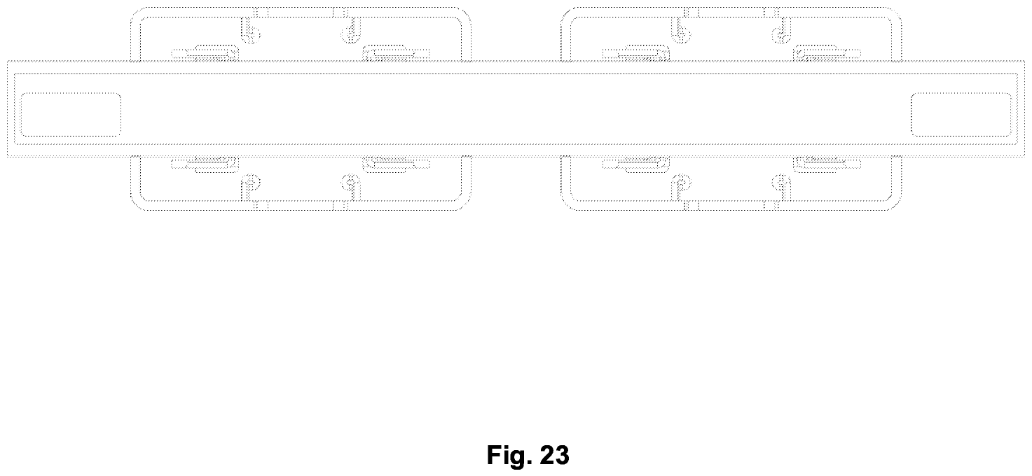

FIG. 23 is a back plan view of the arrangement of FIG. 20 showing the ruler passing through the two cutting jigs. In the arrangement shown, the ruler passes through the apertures located along the longitudinal axes of the respective cutting jigs.

In another arrangement, the ruler runs vertically through the cutting jigs to position the electrical outlets above each other. As indicated above, such an arrangement could readily be rotated through 90 degrees to enable vertically oriented outlets to be marked that are displaced horizontally from each other.

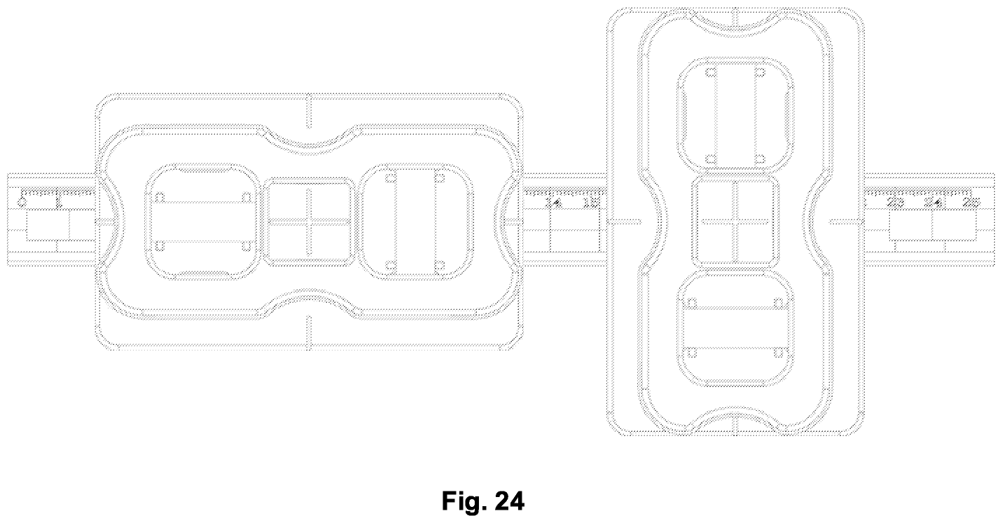

FIG. 24 illustrates an arrangement in which a ruler passes through a longitudinal axis of a first cutting jig and a transverse axis of a second cutting jig.

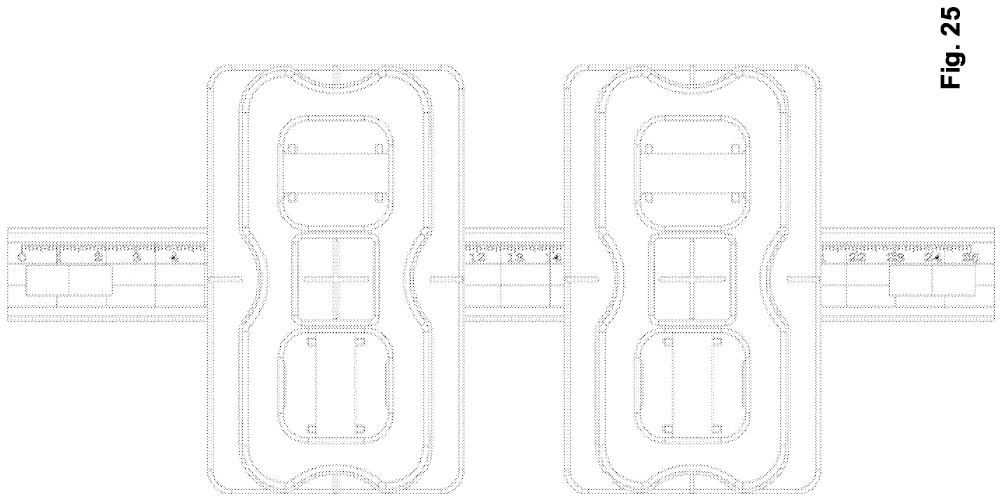

FIG. 25 illustrates an arrangement in which a ruler passes through a transverse axis of first and second cutting jigs. Such an arrangement enables a user to mark two horizontal electrical outlets one above the other. Alternatively, the ruler and attached cutting jigs can be rotated through 90 degrees to enable the user to mark two vertical electrical outlets side by side each other.

It will be appreciated that by using a sufficiently long ruler any number of cutting jigs can be arranged relative to one another. For example, in large commercial premises it may be advantageous to locate three or four or more electrical outlets next to each other, such as when terminating a large number of network cables or providing a number of light switches for a commercial installation. In such a scenario, a sufficiently long ruler, such as a 50 cm or 1 m ruler would enable the user to couple three, four, or more cutting jigs in a selected manner.

### INDUSTRIAL APPLICABILITY

The arrangements described are applicable to the electrical and building industries.

Although the invention has been described with reference to specific examples, it will be appreciated by those skilled in the art that the invention may be embodied in many other forms. The foregoing describes only some embodiments of the present invention, and modifications and/or changes can be made thereto without departing from the scope and spirit of the invention, the embodiments being illustrative and not restrictive.

In the context of this specification, the word “comprising” and its associated grammatical constructions mean “including principally but not necessarily solely” or “having” or “including”, and not “consisting only of”. Variations of the word “comprising”, such as “comprise” and “comprises” have correspondingly varied meanings.

As used throughout this specification, unless otherwise specified, the use of ordinal adjectives “first”, “second”, “third”, “fourth”, etc., to describe common or related objects, indicates that reference is being made to different instances of those common or related objects, and is not intended to imply that the objects so described must be provided or positioned in a given order or sequence, either temporally, spatially, in ranking, or in any other manner.

Reference throughout this specification to “one embodiment,” “an embodiment,” “some embodiments,” or “embodiments” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

While some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practised without these specific details. In other instances, well-known methods, structures and techniques have not been shown in detail in order not to obscure an understanding of this description.

Note that when a method is described that includes several elements, e.g., several steps, no ordering of such elements, e.g., of such steps is implied, unless specifically stated.

The term “coupled” should not be interpreted as being limitative to direct connections only. The terms “coupled” and “connected,” along with their derivatives, may be used. It should be understood that these terms are not intended as synonyms for each other, but may be. Thus, the scope of the expression “a device A coupled to a device B” should not be limited to devices or systems wherein an input or output of device A is directly connected to an output or input of device B. It means that there exists a path between device A and device B which may be a path including other devices or means in between. Furthermore, “coupled to” does not imply direction. Hence, the expression “a device A is coupled to a device B” may be synonymous with the expression “a device B is coupled to a device A”. “Coupled” may mean that two or more elements are either in direct physical or electrical contact, or that two or more elements are not in direct contact with each other but yet still co-operate or interact with each other.

We claim:

1. An electrical outlet cutting jig comprising:
a ruler; and
a body having a lower perimeter,
wherein said body includes a first channel defined along a first axis of said body, wherein said first channel is configured to receive said ruler such that a lower surface of said ruler is flush with said lower perimeter of said body and said ruler can slide within said first channel, and
wherein said body includes a first level indicator and a second level indicator orthogonal to said first level indicator.

2. The cutting jig of claim 1, wherein said lower perimeter is dimensioned to be smaller than an outlet plate to be used in relation to an electrical outlet, wherein the electrical outlet is selected from the group consisting of: a general purpose outlet (GPO) for mains power, a local area network (LAN) cabling outlet, a light switch outlet, a Universal Serial Bus (USB) charging port outlet, and a fan control outlet.

3. The cutting jig of claim 2, wherein said lower perimeter is substantially rectangular having a length in the range of 50 mm to 300 mm and a width in the range of 20 mm to 300 mm.

4. The cutting jig of claim 3, wherein said lower perimeter has a length of 87 mm and a width of 52 mm.

5. The cutting jig of claim 1, wherein said body includes:
a rectangular lower portion having a substantially rectangular rim extending below an upper surface, the bottom of said substantially rectangular rim defining said lower perimeter, wherein said first channel is defined by apertures in a first pair of opposing faces of said substantially rectangular rim.

6. The cutting jig of claim 5, wherein each aperture is associated with a pair of resiliently deformable lugs to frictionally engage said ruler.

7. The cutting jig of claim 6,
wherein each lug has a flange configured to engage frictionally with a longitudinal groove along a side of said ruler, each groove having a plurality of indentations at predefined positions along said ruler, said indentations being adapted to engage with said resiliently deformable lugs.

8. The cutting jig of claim 1, wherein said body includes:
a rectangular lower portion having a substantially rectangular rim extending below an upper surface, the bottom of said substantially rectangular rim defining said lower perimeter, wherein said channel is moulded into said lower portion.

9. The cutting jig of claim 1, wherein said first axis is one of a longitudinal axis and a transverse axis of said body.

10. The cutting jig of claim 1, wherein each of said first level indicator and said second level indicator is implemented using one of a spirit level indicator and an electronic level indicator with an accelerometer.

11. The cutting jig of claim 1, wherein said body further includes:
a grip portion suitable for holding, wherein said grip portion projects above said lower portion.

12. The cutting jig of claim 11, wherein said grip portion includes a plurality of gripping elements.

13. The cutting jig of claim 12, wherein at least one of said gripping elements is a textured region of said grip portion.

14. The cutting jig of claim 11, wherein said grip portion includes a substantially rectangular rim projecting from said upper surface of said lower portion

15. The cutting jig of claim 12, wherein at least one of said gripping elements is a concave cylindrical depression in said rim.

16. The cutting jig of claim 11, wherein said body further includes:
a top plate affixed to said grip portion, said top plate extending beyond an upper perimeter of said grip portion, said top plate including at least one pair of opposing grip elements.

17. The cutting jig of claim 1, wherein:
said body has a second channel defined along a second axis of said body, said second axis being orthogonal to said first axis, wherein said second channel is configured to receive said ruler such that said ruler is flush with said lower perimeter of said body.

18. The cutting jig of claim 5, further comprising:
a second channel defined along a second axis of said body, said second axis being orthogonal to said first axis, wherein said second channel is defined by apertures in a second pair of opposing faces of said substantially rectangular rim, said first pair of opposing faces to being orthogonal to said second pair of opposing faces.

19. The cutting jig of claim 1, wherein said ruler further includes at least one of a horizontal level indicator and a vertical level indicator.
